(19) United States
(12) Patent Application Publication
(10) Pub. No.: US 2026/0296328 A1
(43) Pub. Date: Oct. 1, 2026

(54) ELECTRONIC DEVICE SUPPORT STRUCTURE, WORKING MACHINE, AND FRAME DEVICE

(71) Applicant: HONDA MOTOR CO., LTD., Tokyo (JP)

(72) Inventors: Tatsuya Yamazaki, Wako-shi (JP); Yoshinori Masubuchi, Wako-shi (JP); Satoshi Hatori, Wako-shi (JP); Takuma Kimoto, Wako-shi (JP)

(21) Appl. No.: 19/570,248

(22) Filed: Mar. 18, 2026

(30) Foreign Application Priority Data
Mar. 27, 2025 (JP) 2025-054085

(51) Int. Cl. B60R 11/00; B60R 11/02

(52) U.S. Cl. CPC B60R 11/00; B60R 11/0264; B60R 2011/004; B60R 2011/0049; B60R 2011/008

(57) ABSTRACT

An electronic device support structure for supporting an electronic device connectable to a working machine includes a support portion configured to support the electronic device, and a connecting portion connected to the support portion and connected to a vehicle body frame of the working machine.

### CROSS-REFERENCE TO RELATED APPLICATIONS

This application is based upon and claims the benefit of priority from Japanese Patent Application No. 2025-054085 filed on Mar. 27, 2025, the contents of which are incorporated herein by reference.

### BACKGROUND OF THE INVENTION

### Field of the Invention

The present disclosure relates to an electronic device support structure, a working machine, and a frame device.

### Description of the Related Art

In JP 2016-156223 A, a snow removal machine is disclosed that carries out a snow removal operation based on the operation of operating handlebars by an operator.

### SUMMARY OF THE INVENTION

There is a long-awaited need for a technology that is capable of enabling a working machine to perform at least one of autonomous traveling and autonomous operation depending on the situation around the working machine.

The present invention has the object of solving the aforementioned problem.

The first aspect of the present disclosure is an electronic device support structure for supporting an electronic device connectable to a working machine includes a support portion configured to support the electronic device, and a connecting portion connected to the support portion and connected to a vehicle body frame of the working machine.

A second aspect of the present disclosure is a work machine including the electronic device support structure of the first aspect.

A third aspect of the present disclosure is a frame device including: a support portion configured to support an electronic device configured to be connected to a working machine; and a connecting portion connected to the support portion and connected to a vehicle body frame of the working machine.

According to the present disclosure, the working machine can perform at least one of autonomous traveling and autonomous operation depending on the surrounding situation.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a left side view of a working machine according to one embodiment;

FIG. 2 is a plan view of the working machine shown in FIG. 1;

FIG. 3 is a rear view of the working machine shown in FIG. 1;

FIG. 4 is a bottom view of the working machine shown in FIG. 1;

FIG. 5 is a perspective view of a frame device shown in FIG. 1;

FIG. 6 is a diagram showing a recognition range of a first recognition unit;

FIG. 7 is a diagram showing a recognition range of a second recognition unit;

FIG. 8 is a diagram showing the recognition range of the first recognition unit; and

FIG. 9 is a diagram showing the recognition range of the second recognition unit.

### DETAILED DESCRIPTION OF THE INVENTION

In recent years, various automation in working machines has been advanced. In particular, there is a long-awaited need for a technology (for example, a technology related to the arrangement of a sensor or a control unit) that enables the working machine to easily recognize the situation around the working machine (for example, a working area of a working unit) using a recognition unit and to perform at least one of autonomous traveling and autonomous operation, based on recognition results of the recognition unit.

According to the present disclosure, an electronic device support structure, a working machine, and a frame device are provided that make is possible for the working machine to perform at least one of autonomous traveling and autonomous operation depending on the situation around the working machine.

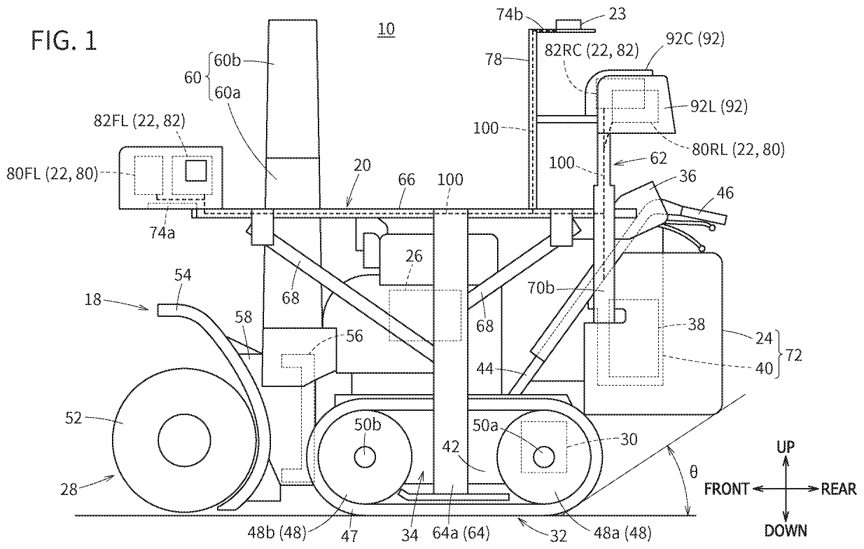

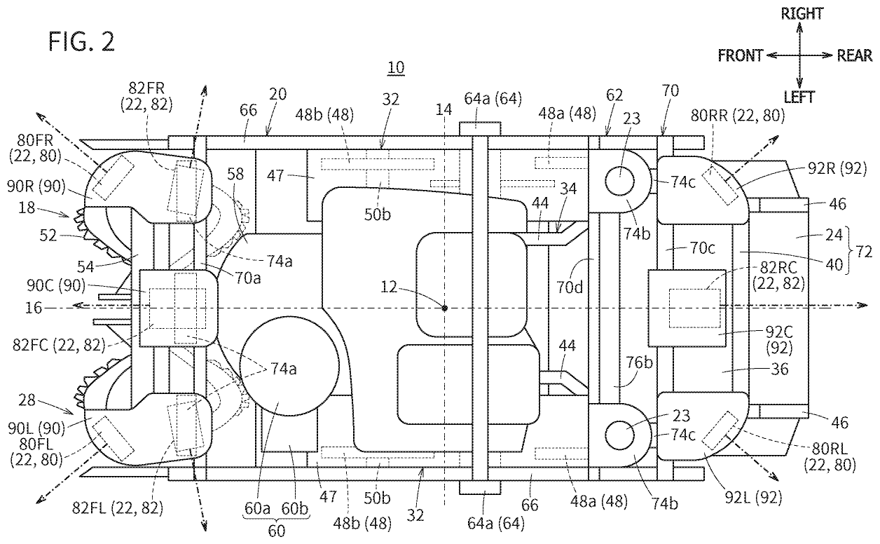

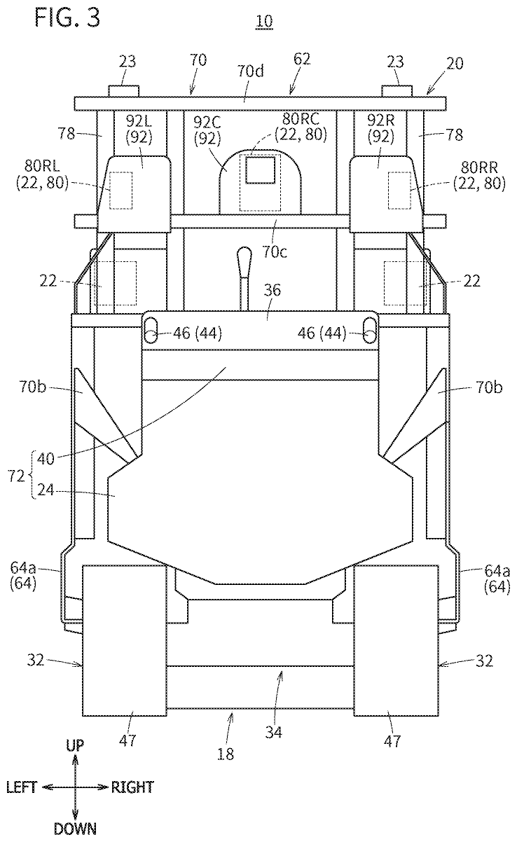

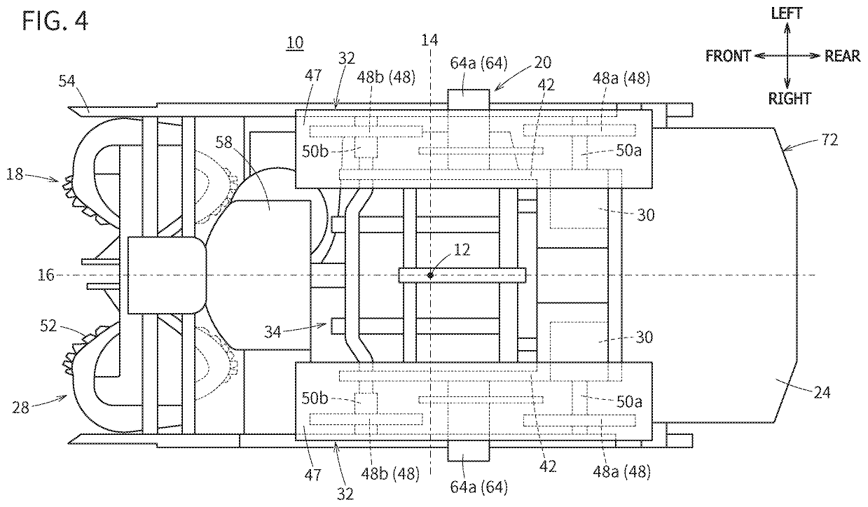

A description will be given with reference to FIG. 1 to FIG. 9 concerning a working machine 10 according to one embodiment. FIG. 1 is a left side view of a working machine 10 according to one embodiment. FIG. 2 is a plan view of the working machine 10. FIG. 3 is a rear view of the working machine 10. FIG. 4 is a bottom view of the working machine 10. In the following description, the direction in which the working machine 10 moves forward is defined as a frontward direction, and the direction in which the working machine 10 moves rearward is defined as a rearward direction, and a front-rear direction, a left-right direction (a vehicle widthwise direction), and an upper-lower direction will be described. The front-rear direction is a direction (a movement direction of the working machine 10) in which the working machine 10 moves forward or moves rearward. The front-rear direction and the left-right direction are horizontal directions of the working machine 10. The upper-lower direction is a direction (a vertical direction) that is perpendicular to the horizontal direction of the working machine 10.

As shown in FIG. 2, as viewed in plan, a center in a front-rear direction and a left-right direction of the working machine 10 is defined as a center point (a front-rear center, a left-right center) 12. A center line that passes through the center point 12 of the working machine 10, and further, extends in the left-right direction is defined as a front-rear center line (a front-rear center) 14. Accordingly, a side (a front side) that is more frontward than the front-rear center line 14 in the working machine 10 is a front side portion (a front part) of the working machine 10. A side (a rear side) that is more rearward than the front-rear center line 14 in the working machine 10 is a rear side portion (a rear part) of the working machine 10. A center line that passes through the center point 12 of the working machine 10, and further, extends in the front-rear direction is defined as a left-right center line (a left-right center) 16. Accordingly, a side (a left side) that is more leftward than the left-right center line 16 in the working machine 10 is a left side portion (a left part) of the working machine 10. A side (a right side) that is more rightward than the left-right center line 16 in the working machine 10 is a right side portion (a right part) of the working machine 10.

As shown in FIG. 1 to FIG. 4, the working machine 10 is a working machine that is capable of carrying out at least one from among autonomous traveling and autonomous operation. The working machine 10 is a snow removal machine. The snow removal machine is a working machine that is used to carry out the removal of snow. The working machine 10, although not necessarily limited to this feature, is a snow removal machine that can be pushed from behind by a user to carry out the snow removal operation. In the following description, a description will be given concerning a case in which the working machine 10 is a snow removal machine.

The working machine 10 includes a working machine main body 18, a frame device (a mounting frame, an electronic device support structure) 20, surrounding vicinity recognition units (recognition units, an electronic devices) 22, position recognition units (recognition units, electronic devices) 23, and a frame side control unit (an electronic device, a control unit) 24.

The working machine main body 18 is equipped with a configuration that is similar to that of the snow removal machine described in JP 2016-156223 A. More specifically, the working machine main body 18 is capable of carrying out a snow removal operation without being equipped with the frame device 20, the surrounding vicinity recognition units 22, the position recognition units 23, and the frame side control unit 24.

In detail, the working machine main body 18 includes an engine 26, a working unit 28, a pair of left and right electric motors 30, a pair of left and right traveling units 32, a vehicle body frame 34, an operating unit 36, a battery 38, and a main body side control unit (a control unit) 40.

The vehicle body frame 34 constitutes a machine body of the working machine main body 18. The vehicle body frame 34 is equipped with a pair of left and right crawler frames (first partial frames) 42, and a pair of left and right operating handlebars (second partial frames) 44.

The pair of left and right crawler frames 42 are disposed at both end parts of the vehicle body frame 34 in the vehicle widthwise direction (the left-right direction). As shown in FIG. 4, the pair of left and right crawler frames 42 sandwich the left-right center line 16, and are disposed on the vehicle body frame 34 with a space therebetween in the vehicle widthwise direction. The crawler frames 42, while straddling over the front-rear center line 14, extend in the front-rear direction.

As shown in FIG. 1 to FIG. 3, the pair of left and right operating handlebars 44 are provided on a rear part of the vehicle body frame 34. The pair of left and right operating handlebars 44 are positioned more rearward than the front-rear center line 14. The pair of left and right operating handlebars 44 sandwich the left-right center line 16, and are disposed on a rear part of the vehicle body frame 34 with a space therebetween in the vehicle widthwise direction. The operating handlebars 44 extend rearward and upward. Grips 46 are mounted on distal end parts of the operating handlebars 44. The user, by grasping the grips 46, is capable of operating the operating handlebars 44. In the present embodiment, the distal end parts (the grips 46) of the operating handlebars 44 may be included in the operating unit 36. The operating handlebars 44 and the frame side control unit 24, from among the constituent elements of the working machine 10, project out the farthest to the rear. The distal end parts of the operating handlebars 44 (the rear ends of the grips 46) and the rear end of the frame side control unit 24 make up a rear end of the working machine 10.

The engine 26 is supported on an upper part of the vehicle body frame 34. The engine 26 can be positioned in close proximity to the center point 12. The engine 26 is a motive power source in order to drive the working unit 28.

As shown in FIG. 4, the pair of left and right electric motors 30 are positioned more rearward than the front-rear center line 14. The pair of left and right electric motors 30 sandwich the left-right center line 16, and are supported on a rear part of the vehicle body frame 34 with a space therebetween in the vehicle widthwise direction. As shown in FIG. 1, the pair of left and right electric motors 30 are positioned downward of the pair of left and right operating handlebars 44.

As shown in FIG. 1 to FIG. 4, the pair of left and right traveling units 32 are disposed on both end parts in the vehicle widthwise direction of the vehicle body frame 34. The pair of left and right traveling units 32 sandwich the left-right center line 16, and are disposed on both end parts of the vehicle body frame 34 with a space therebetween in the vehicle widthwise direction. The traveling units 32, while straddling over the front-rear center line 14, extend in the front-rear direction.

The traveling units 32 are equipped with crawler belts 47 and vehicle wheels 48. The vehicle wheels 48 include driving wheels 48a and rolling wheels 48b. Drive shaft portions 50a are provided on rear parts of the crawler frames 42. Rolling shaft portions 50b are provided on front parts of the crawler frames 42.

The drive shaft portions 50a are positioned more rearward than the front-rear center line 14. The drive shaft portions 50a extend toward outer sides in the vehicle widthwise direction from the rear parts of the crawler frames 42. The driving wheels 48a are rotatably supported by the drive shaft portions 50a. The rolling shaft portions 50b are positioned more frontward than the front-rear center line 14.

The rolling shaft portions 50b extend toward outer sides in the vehicle widthwise direction from the front parts of the crawler frames 42. The rolling wheels 48b are rotatably supported by the rolling shaft portions 50b. Therefore, in the traveling units 32, the rolling wheels 48b and the driving wheels 48a sandwich the front-rear center line 14, and are disposed with a space therebetween in the front-rear direction.

The crawler belts 47 are wound around the driving wheels 48a and the rolling wheels 48b, along the front-rear direction, in a manner so as to straddle over the front-rear center line 14.

The left side electric motor 30 drives the left side traveling unit 32. The right side electric motor 30 drives the right side traveling unit 32. Specifically, by the electric motors 30 being driven, the driving wheels 48a are rotated. By the driving wheels 48a being rotated, the crawler belts 47 are driven. By the crawler belts 47 being driven, the working machine main body 18 can be made to move forward or move rearward.

The working unit 28 is positioned more frontward than the front-rear center line 14. The working unit 28, while straddling over the left-right center line 16, is supported on a front portion of the vehicle body frame 34. The working unit 28 includes an auger 52, an auger housing 54, a blower 56, a blower case 58, and a snow throwing unit 60.

The blower case 58, while straddling over the left-right center line 16, is connected to the front portion of the vehicle body frame 34. The blower 56 is provided in the interior of the blower case 58.

The auger housing 54 is connected to a front part of the blower case 58. The auger housing 54, while straddling over the left-right center line 16, extends in the vehicle widthwise direction. The auger housing 54 is open to the front. Among each of the constituent elements of the working unit 28, the auger housing 54 projects out the farthest in the vehicle widthwise direction. Therefore, both end parts in the vehicle widthwise direction of the auger housing 54 are both end parts in the vehicle widthwise direction of the working unit 28.

The auger 52 is disposed in the auger housing 54. A portion of the auger 52 projects out frontward from the auger housing 54. Among each of the constituent elements of the working machine 10, the auger 52 projects out the farthest in the frontward direction. Therefore, the front end part of the auger 52, together with being a front end part of the working machine 10, is also a front end part of the working unit 28.

The snow throwing unit 60 is disposed on an upper part of the blower case 58. The snow throwing unit 60 includes a chute 60a, and a chute guide 60b.

A base end part of the chute 60a is positioned more leftward than the left-right center line 16 above the upper part of the blower case 58, although the present disclosure is not necessarily limited to this feature. The chute 60a extends upward from the upper part of the blower case 58. The chute 60a, on the upper part of the blower case 58, is rotatable about a vertical axis.

The chute guide 60b is mounted on an upper end part of the chute 60a. The chute guide 60b is capable of swinging in the upward-downward direction with respect to the chute 60a. The chute guide 60b, among the constituent elements of the working unit 28, is positioned at the uppermost location. The chute guide 60b is an upper end of the working unit 28. Further, the chute guide 60b, by being swung upward, is capable of projecting out more upward than the other constituent elements of the working machine 10. The upper end of the chute guide 60b can serve as the upper end of the working unit 28. Moreover, it should be noted that the chute guide 60b, since it is capable of being swung in the upward-downward direction, does not necessarily always project out more upward than the other constituent elements of the working machine 10. In the case that the chute guide 60b is swung in the downward direction, and the chute guide 60b is positioned more downward than the position recognition units 23, the position recognition units 23 can serve as the upper end of the working machine 10.

The motive power of the engine 26 is transmitted, via a non-illustrated motive power transmission mechanism, to the auger 52 and the blower 56. The auger 52, by being driven by the motive power that is transmitted from the engine 26, gathers up snow that exists within the operating range of the auger 52. Moreover, the operating range of the auger 52 is a region on an inner side of the auger housing 54, and further, that exists between the front end and the rear end of the auger 52. The snow that is collected by the auger 52 is delivered via the blower 56 to the snow throwing unit 60. The snow throwing unit 60 hurls (throws) far away the snow that is collected by the auger 52. The chute 60a, by being rotated about a vertical axis, can adjust the direction in which the snow is thrown (the orientation of the snow throwing). Further, by swinging the chute guide 60b in the upward-downward direction, it is possible to adjust the snow throwing angle. Moreover, it should be noted that the operating range of the snow throwing unit 60 includes the range of rotation of the chute 60a, and the swinging range of the chute guide 60b.

The operating unit 36, the main body side control unit 40, and the battery 38 are positioned more rearward than the front-rear center line 14. The operating unit 36, the main body side control unit 40, and the battery 38 are disposed between the pair of left and right operating handlebars 44. The operating unit 36, the main body side control unit 40, and the battery 38 are positioned, in the upward-downward direction, between the grips 46 and the electric motors 30.

The operating unit 36, together with being disposed so as to straddle over the left-right center line 16, is positioned in a manner so as to overlap the grips 46 in the upward-downward direction. The operating unit 36 is mounted on the pair of left and right operating handlebars 44. The user, by operating the operating unit 36, is capable of causing the working machine main body 18 to move forward, to move rearward, to turn, or to stop. Further, the user, by operating the operating unit 36, can cause the engine 26 to be started or to be stopped.

The main body side control unit 40 is positioned downward of the operating unit 36, in a manner so as to straddle over the left-right center line 16. The main body side control unit 40 is supported by the pair of left and right operating handlebars 44. The battery 38 is, downward of the operating unit 36, supported integrally with the main body side control unit 40 by the pair of left and right operating handlebars 44. The main body side control unit 40 is driven by the electrical power that is supplied from the battery 38. The main body side control unit 40 is equipped with a non-illustrated internal memory. The main body side control unit 40, by reading out and executing programs that are stored in the memory, is capable of executing various control processes.

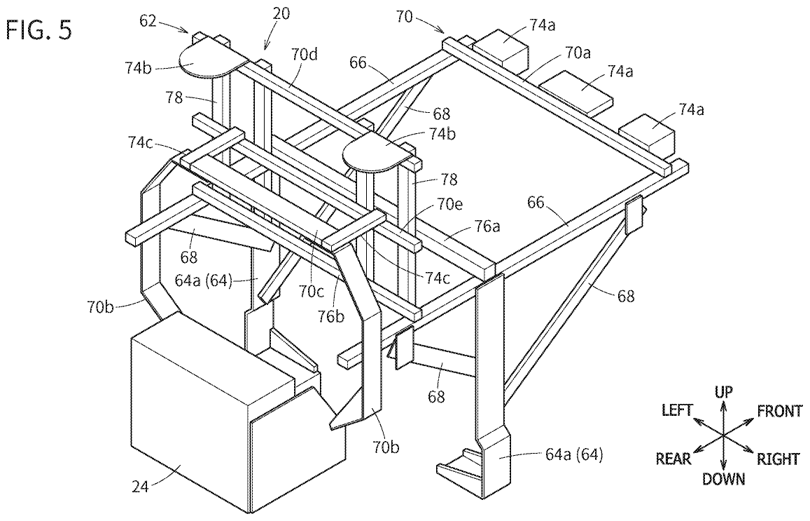

The frame device 20 is mounted on the vehicle body frame 34. The frame device 20 is capable of being attached and detached with respect to the vehicle body frame 34. As noted previously, since the working machine main body 18 is capable of independently carrying out the snow removal operation, the frame device 20 is mounted in the form of an after-market attachment on the working machine main body 18. As shown in FIG. 5, the frame device 20 includes a support portion 62 and a connecting portion 64.

As shown in FIG. 4, the connecting portion 64 is connected to the vehicle body frame 34. The connecting portion 64 is capable of being attached and detached with respect to the vehicle body frame 34. The connecting portion 64 is mounted on the vehicle body frame 34 in a manner so that the relative position thereof with respect to the vehicle body frame 34 is capable of being adjusted. Further, the connecting portion 64 is mounted on a portion of the vehicle body frame 34 where the vibrations that are generated at a time when the working machine 10 is in operation are relatively small.

As shown in FIG. 5, the connecting portion 64 includes a pair of left and right connecting frames 64a. The connecting frames 64a are L-shaped frames. As shown in FIG. 3, the connecting frames 64a extend in the upward-downward direction, on a more outer side in the vehicle widthwise direction than the crawler belts 47. As shown in FIG. 3 and FIG. 4, the lower end parts of the connecting frames 64a, at a location between the crawler frames 42 and the lower parts of the crawler belts 47, are bent toward inner sides in the vehicle widthwise direction. The lower end parts of the connecting frames 64a are connected to the crawler frames 42. Specifically, the lower end parts of the connecting frames 64a are connected at locations of the crawler frames 42 between the rolling wheels 48b and the driving wheels 48a. As shown in FIG. 5, the upper end parts of the connecting frames 64a are connected to front-rear connecting frames 66 that extend in the front-rear direction.

The connecting frames 64a are detachable with respect to the crawler frames 42 (refer to FIG. 1). Further, the connecting frames 64a, for example, are capable of being adjusted in position in the upward-downward direction with respect to the crawler frames 42. The crawler frames 42 are mounted on portions of the vehicle body frame 34 where the vibrations that are generated at a time when the working machine 10 is in operation are relatively small.

The connecting frames 64a and the front-rear connecting frames 66 are connected via a plurality of reinforcing frames 68. One end part of each of the reinforcing frames 68 is connected to an intermediate portion of the connecting frames 64a between the upper end part and the lower end part. The other end part of each of the reinforcing frames 68 is connected to a front side portion or rear side portion of each of the front-rear connecting frames 66.

As shown in FIG. 2 to FIG. 4, the pair of left and right connecting frames 64a, among the constituent elements of the working machine 10, project out the farthest toward the outer side in the vehicle widthwise direction. Therefore, the outer end parts in the vehicle widthwise direction of the pair of left and right connecting frames 64a are both end parts in the vehicle widthwise direction of the working machine 10.

The support portion 62 is capable of supporting various electronic devices, which will be described later. As shown in FIG. 5, the support portion 62 includes a plurality of support frames 70. The plurality of support frames 70 include a front side support frame 70a, a pair of left and right rear side support frames 70b, a first left and right support frame 70c, a second left and right support frame 70d, and a third left and right support frame 70e. As noted previously, the electronic device includes a plurality of the surrounding vicinity recognition units 22 (see FIGS. 1 to 3), a plurality of the position recognition units 23, and the frame side control unit 24. These electronic devices, by the frame device 20 being mounted on the working machine main body 18, are provided in the form of after-market attachments on the working machine main body 18.

As shown in FIG. 1 to FIG. 5, the frame side control unit 24 is equipped with non-illustrated memory. The frame side control unit 24, by reading out and executing programs that are stored in the memory, is capable of executing various control processes. The frame side control unit 24 is electrically connected, via non-illustrated wiring, to the main body side control unit 40. By the frame side control unit 24 and the main body side control unit 40, a control device (a control unit) 72 that controls each of respective parts of the working machine 10 is constituted. The control device 72 is capable of controlling each of the respective parts of the working machine 10. In this case, the frame side control unit 24 and the main body side control unit 40 may work together in cooperation, and thereby may control each of the respective parts of the working machine 10. Alternatively, from among the frame side control unit 24 and the main body side control unit 40, at least one thereof may control each of the respective parts of the working machine 10. The working machine 10, by being equipped with the frame side control unit 24, can perform autonomous travel and autonomous work.

As shown in FIG. 1, front end parts of the pair of left and right front-rear connecting frames 66 are positioned upward of the auger housing 54. Specifically, as shown in FIG. 1 and FIG. 2, the front end parts of the pair of left and right front-rear connecting frames 66 are positioned upward of both end parts in the vehicle widthwise direction of the auger housing 54. The front end parts of the front-rear connecting frames 66 are positioned in a manner so as to avoid the operating range of the working unit 28. Moreover, the operating range of the working unit 28 includes the operating range of the auger 52, the operating range of the snow throwing unit 60, and the operating range of the blower 56.

As shown in FIG. 5, the front end parts of the pair of left and right front-rear connecting frames 66 are connected via the front side support frame 70a. As shown in FIG. 2, the front side support frame 70a, while straddling over the left-right center line 16, extends in the left-right direction. A left end part of the front side support frame 70a is connected to a front end part of the left side front-rear connecting frame 66. A right end part of the front side support frame 70a is connected to a front end part of the right side front-rear connecting frame 66.

As shown in FIG. 5, three of the brackets 74a are mounted on the front side support frame 70a with a space therebetween in the left-right direction. As shown in FIG. 1 and FIG. 2, the brackets 74a, together with being positioned more rearward than the front end part of the working unit 28, are positioned more frontward than the rear end of the working machine 10. Further, the brackets 74a are positioned more downward than the upper end of the working machine 10, and further, are positioned more on an inner side in the vehicle widthwise direction than both end parts in the vehicle widthwise direction of the working unit 28. Furthermore, the brackets 74a are positioned upward of the auger housing 54. Further, the brackets 74a are disposed in a manner so as not to overlap with the operating range of the working unit 28.

A central bracket 74a is positioned on the left-right center line 16. The left side bracket 74 a is positioned on the left side of the front side support frame 70a. The left side bracket 74a, as viewed in plan, is positioned more on an inner side in the vehicle widthwise direction than a left end part of the auger housing 54. The right side bracket 74a is positioned on the right side of the front side support frame 70a. The right side bracket 74a, as viewed in plan, is positioned more on an inner side in the vehicle widthwise direction than a right end part of the auger housing 54.

The rear end parts of the pair of left and right front-rear connecting frames 66 are positioned rearward of the traveling units 32. Specifically, the rear end parts of the front-rear connecting frames 66 are positioned upward of the traveling units 32, on more outer sides in the vehicle widthwise direction than the operating handlebars 44. As shown in FIG. 5, the rear side support frames 70b are connected to the rear end parts of the front-rear connecting frames 66. The rear side support frames 70b extend in the upward-downward direction. Intermediate portions of the rear side support frames 70b are connected to the rear end parts of the front-rear connecting frames 66. Lower end parts of the pair of left and right rear side support frames 70b support the frame side control unit 24 in the vehicle widthwise direction. As shown in FIG. 3 and FIG. 5, the pair of left and right rear side support frames 70b support the frame side control unit 24, in a manner so that the frame side control unit 24 is positioned between the pair of left and right operating handlebars 44.

As shown in FIG. 1, the upper ends of the pair of left and right rear side support frames 70b are positioned more upward than the operating handlebars 44, and further, more downward than the upper end of the working machine 10. As shown in FIG. 5, the upper ends of the pair of left and right rear side support frames 70b are connected via the first left and right support frame 70c that extends in the left-right direction.

The pair of left and right front-rear connecting frames 66 are connected via a first left-right connecting frame 76a and a second left-right connecting frame 76b. The first left-right connecting frame 76a and the second left-right connecting frame 76b are spaced apart in the front-rear direction, and serve to connect the pair of left and right front-rear connecting frames 66 in the left-right direction. The first left-right connecting frame 76a connects in the left-right direction the connecting locations of at which the pair of left and right front-rear connecting frames 66 is connected with the connecting frames 64a. The second left-right connecting frame 76b is positioned between the first left-right connecting frame 76a and the pair of left and right rear side support frames 70b. The second left-right connecting frame 76b connects in the left-right direction locations of the pair of left and right front-rear connecting frames 66 located between the first left-right connecting frame 76a and the rear side support frames 70b. A plurality of upward-downward connecting frames 78 are connected to the second left-right connecting frame 76b.

The plurality of upward-downward connecting frames 78 are connected to the second left-right connecting frame 76b with a space therebetween in the left-right direction. Lower end parts of the plurality of upward-downward connecting frames 78 are connected to the second left-right connecting frame 76b. The plurality of upward-downward connecting frames 78 extend upward from the second left-right connecting frame 76b.

The second left and right support frame 70d and the third left and right support frame 70e are connected to the plurality of upward-downward connecting frames 78. The second left and right support frame 70d and the third left and right support frame 70e extend in the left-right direction with a space therebetween in the upward-downward direction. The second left and right support frame 70d connects in the left-right direction the upper end parts of the plurality of upward-downward connecting frames 78. The third left and right support frame 70e connects in the left-right direction the intermediate portions of the plurality of upward-downward connecting frames 78 between the upper end part and the lower end part. The third left and right support frame 70e is positioned at approximately the same height as the first left and right support frame 70c.

As shown in FIG. 2, two plate shaped brackets 74b sandwich the left-right center line 16, and are mounted on the second left and right support frame 70d with a space therebetween in the left-right direction. As shown in FIG. 1 and FIG. 2, the brackets 74b, together with being positioned more rearward than the front end part of the working unit 28, are positioned more frontward than the rear end of the working machine 10. Further, the brackets 74b, together with being positioned more downward than the upper end of the working machine 10, are positioned more on an inner side in the vehicle widthwise direction than both end parts in the vehicle widthwise direction of the working unit 28. Furthermore, the brackets 74b are positioned more upward than the brackets 74a that are disposed on the front side support frame 70a. As shown in FIG. 5, the left side bracket 74b is disposed on the left end part of the second left and right support frame 70d. The right side bracket 74b is disposed on the right end part of the second left and right support frame 70d.

Two rod shaped brackets 74c are suspended in the front-rear direction, between the pair of left and right rear side support frames 70b and the third left and right support frame 70e. The two of the brackets 74c sandwich the left-right center line 16 (refer to FIG. 2), and span across the pair of left and right rear side support frames 70b and the third left and right support frame 70e with a space therebetween in the left-right direction. The brackets 74c, together with being positioned more rearward than the front end part of the working unit 28, are positioned more frontward than the rear end of the working machine 10. Further, the brackets 74c, together with being positioned more downward than the upper end of the working machine 10, are positioned more on an inner side in the vehicle widthwise direction than both end parts in the vehicle widthwise direction of the working unit 28. Furthermore, the brackets 74c, together with being positioned more upward than the three of the brackets 74a that are disposed on the front side support frame 70a, are positioned more downward than the two of the brackets 74b that are disposed on the second left and right support frame 70d. The left side bracket 74c connects the upper end part of the rear side support frame 70b on the left side to the left side portion of the third left and right support frame 70e. The right side bracket 74c connects the upper end part of the rear side support frame 70b on the right side to the right side portion of the third left and right support frame 70e.

Moreover, it should be noted that the electronic device described above is not necessarily limited to being directly supported by the support portion 62. The aforementioned electronic device may be indirectly supported, via a non-illustrated joint, by the support portion 62. In other words, in the present embodiment, supporting of the electronic device by the support portion 62 includes both a case in which the electronic device is supported by directly connecting the electronic device to the support portion 62, and a case in which the electronic device is supported by indirectly connecting the electronic device to the support portion 62.

As shown in FIG. 1 to FIG. 3, the working machine 10 is equipped with a plurality of recognition units. The plurality of recognition units are a plurality of the surrounding vicinity recognition units (recognition units) 22 that recognize the surrounding vicinity of the working machine 10, and a plurality of the position recognition units 23 that recognize the current position of the working machine 10.

The plurality of surrounding vicinity recognition units 22 are disposed at least one from among frontward with respect to the front-rear center line 14, or rearward with respect to the front-rear center line 14. More specifically, the plurality of surrounding vicinity recognition units 22 include a frontward recognition unit that is positioned more frontward than the front-rear center line 14, and a rearward recognition unit that is positioned more rearward than the front-rear center line 14. The frontward recognition unit is positioned more downward than the upper end of the working machine 10. The frontward recognition unit, together with overlapping with the working unit 28 as viewed in plan, does not overlap with the operating range of the working unit 28 as viewed from the side. Further, the number of the rearward recognition units is less than the number of the frontward recognition units. The rearward recognition unit is disposed more upward than the frontward recognition unit. The rearward recognition unit is disposed more downward than the upper end of the working machine 10, and further, upward of the control device 72.

Further, the surrounding vicinity recognition units 22 are disposed more on the inner side in the vehicle widthwise direction than both ends in the vehicle widthwise direction of the working machine 10. Specifically, the surrounding vicinity recognition units 22 are disposed more on the inner side in the vehicle widthwise direction than both ends in the vehicle widthwise direction of the working unit 28. More specifically, the surrounding vicinity recognition units 22 are disposed in closer vicinity to the left-right center line 16 than both ends in the vehicle widthwise direction of the working unit 28.

Furthermore, the surrounding vicinity recognition units 22 include left side recognition units that are disposed more on the left side than the left-right center line 16, and right side recognition units that are disposed more on the right side than the left-right center line 16. The left side recognition units include a front left recognition unit that is disposed more frontward than the front-rear center line 14, and a rear left recognition unit that is disposed more rearward than the front-rear center line 14. The right side recognition units include a front right recognition unit that is disposed more frontward than the front-rear center line 14, and a rear right recognition unit that is disposed more rearward than the front-rear center line 14. The front left recognition unit and the front right recognition unit are disposed more rearward than a front end part of the working unit 28, overlap with the working unit 28 as viewed in plan, and further, do not overlap with the operating range of the working unit 28 as viewed from the side. The rear left recognition unit and the rear right recognition unit are disposed more downward than the upper end of the working machine 10, and further, upward of the control device 72.

The surrounding vicinity recognition units 22 include a first recognition unit 80 that recognizes the surrounding vicinity of the working machine 10 using a first recognition mechanism, and a second recognition unit 82 that recognizes the surrounding vicinity of the working machine 10 using a second recognition mechanism that differs from the first recognition mechanism. The second recognition unit 82 has a wider recognition range than the first recognition unit 80, or has a higher distance measurement capacity than the first recognition unit 80, or alternatively, has a wider recognition range and a higher distance measurement capacity than the first recognition unit 80.

Each of the frontward recognition unit and the rearward recognition unit includes two types of recognition units with different recognition mechanisms. Each of the frontward recognition unit and the rearward recognition unit includes the first recognition unit 80 and the second recognition unit 82.

The first recognition unit 80 is a radar sensor. The first recognition unit 80 is a distance measurement sensor that serves to detect the surrounding vicinity of the working machine 10. The first recognition unit 80, by irradiating radio waves such as millimeter waves or the like around the vicinity of the working machine 10, and by receiving reflected waves of the radio waves from a working target object and surrounding objects existing around the vicinity of the working machine 10 (the first recognition mechanism), recognizes the distance and the direction to the working target object and the surrounding objects, as well as the shapes of the working target object and the surrounding objects. The working target object is an object that serves as a working target object performed by the working machine 10. Specifically, the working target object is snow. Further, the surrounding objects, for example, are obstacles that can become impediments to the work of the working machine 10.

The second recognition unit 82 is a LiDAR sensor. The second recognition unit 82 is a distance measurement sensor that detects the surrounding vicinity of the working machine 10, by using a recognition mechanism that differs from that of the first recognition unit 80. The second recognition unit 82, by irradiating laser light around the vicinity of the working machine 10, and by receiving reflected light of the laser light from the working target object and surrounding objects existing around the vicinity of the working machine 10 (the second recognition mechanism), recognizes the distance and the direction to the working target object and the surrounding objects, as well as the shapes of the working target object and the surrounding objects.

Specifically, the frontward recognition unit includes two first recognition units 80 and three second recognition units 82. The two first recognition units 80 and the three second recognition units 82 are disposed on a front part of the working machine 10.

The two first recognition units 80 are disposed respectively on the left side and the right side with respect to the left-right center line 16. From among the three second recognition units 82, one of the second recognition units 82 is disposed on the left-right center line 16. The remaining two of the second recognition units 82 are disposed respectively on the left side and the right side with respect to the left-right center line 16.

More specifically, three front side accommodation units 90 are provided on the front side of the working machine 10. Three rear side accommodation units 92 are provided on the rear side of the working machine 10. Each of the front side accommodation units 90 and the rear side accommodation units 92 accommodates therein at least one of the first recognition units 80 and the second recognition units 82. The first recognition units 80 and the second recognition units 82, by being accommodated respectively in the front side accommodation units 90 and the rear side accommodation units 92, are protected from the exterior.

The three front side accommodation units 90 are disposed on the three brackets 74a (refer to FIG. 5). Therefore, the three front side accommodation units 90 are positioned more rearward than the front end part of the working machine 10, and further, more downward than the upper end of the working machine 10. Further, the three front side accommodation units 90, together with overlapping with the working unit 28 as viewed in plan, do not overlap with the operating range of the working unit 28 as viewed from the side. The three front side accommodation units 90, as viewed in plan, are positioned more on an inner side in the vehicle widthwise direction than both end parts in the vehicle widthwise direction of the working unit 28.

From among the three front side accommodation units 90, a front central accommodation unit 90C is disposed on the central bracket 74a that passes through the left-right center line 16. One of the second recognition units 82 is accommodated in the front central accommodation unit 90C. The second recognition unit 82 that is accommodated in the front central accommodation unit 90C is a front center second recognition unit (frontward recognition unit) 82FC. A sensor surface of the front center second recognition unit 82FC faces frontward. The front center second recognition unit 82FC recognizes the distance and the direction to the working target object and the surrounding objects that are positioned frontward of the working machine 10.

From among the three front side accommodation units 90, a front left accommodation unit 90L is disposed on a left side bracket 74a. One of the first recognition units 80 and one of the second recognition units 82 are accommodated in the front left accommodation unit 90L. The first recognition unit 80 that is accommodated in the front left accommodation unit 90L is a front left first recognition unit (frontward recognition unit, left recognition unit, front left recognition unit) 80FL. The second recognition unit 82 that is accommodated in the front left accommodation unit 90L is a front left second recognition unit (frontward recognition unit, left recognition unit, front left recognition unit) 82FL. In the interior of the front left accommodation unit 90L, the front left first recognition unit 80FL and the front left second recognition unit 82FL are disposed alongside one another in the front-rear direction. The front left first recognition unit 80FL is disposed more frontward than the front left second recognition unit 82FL.

The front left first recognition unit 80FL is accommodated in the front left accommodation unit 90L, in a manner so as to recognize an area diagonally frontward to the left from the working machine 10. More specifically, the front left first recognition unit 80FL is positioned in the interior of the front left accommodation unit 90L, in a manner so that a sensor surface of the front left first recognition unit 80FL faces diagonally frontward to the left (in a leftward direction and a frontward direction) from the working machine 10. The front left first recognition unit 80FL recognizes the distance and the direction to the working target object and the surrounding objects that are positioned diagonally frontward to the left from the working machine 10.

The front left second recognition unit 82FL is accommodated in the front left accommodation unit 90L, in a manner so as to recognize an area on a left side and diagonally rearward to the left from the working machine 10. More specifically, the front left second recognition unit 82FL is positioned in the interior of the front left accommodation unit 90L, in a manner so that a sensor surface of the front left second recognition unit 82FL faces diagonally rearward to the left (in a leftward direction and a rearward direction) from the working machine 10. The front left second recognition unit 82FL recognizes the distance and the direction to the working target object and the surrounding objects that are positioned on the left side and diagonally rearward to the left from the working machine 10.

From among the three front side accommodation units 90, a front right accommodation unit 90R is disposed on a right side bracket 74a. The front right accommodation unit 90R has a shape obtained by having left-right inverted the front left accommodation unit 90L. One of the first recognition units 80 and one of the second recognition units 82 are accommodated in the front right accommodation unit 90R. The first recognition unit 80 that is accommodated in the front right accommodation unit 90R is a front right first recognition unit (frontward recognition unit, right recognition unit, front right recognition unit) 80FR. The second recognition unit 82 that is accommodated in the front right accommodation unit 90R is a front right second recognition unit (frontward recognition unit, right recognition unit, front right recognition unit) 82FR. In the interior of the front right accommodation unit 90R, the front right first recognition unit 80FR and the front right second recognition unit 82FR are disposed alongside one another in the front-rear direction. The front right first recognition unit 80FR is disposed more frontward than the front right second recognition unit 82FR.

The front right first recognition unit 80FR is accommodated in the front right accommodation unit 90R, in a manner so as to recognize an area diagonally frontward to the right from the working machine 10. More specifically, the front right first recognition unit 80FR is positioned in the interior of the front right accommodation unit 90R, in a manner so that a sensor surface of the front right first recognition unit 80FR faces diagonally frontward to the right (in a rightward direction and a frontward direction) from the working machine 10. The front right first recognition unit 80FR recognizes the distance and the direction to the working target object and the surrounding objects that are positioned diagonally frontward to the right from the working machine 10.

The front right second recognition unit 82FR is accommodated in the front right accommodation unit 90R, in a manner so as to recognize an area on a right side and diagonally rearward to the right from the working machine 10. More specifically, the front right second recognition unit 82FR is positioned in the interior of the front right accommodation unit 90R, in a manner so that a sensor surface of the front right second recognition unit 82FR faces diagonally rearward to the right (in a rightward direction and a rearward direction) from the working machine 10. The front right second recognition unit 82FR recognizes the distance and the direction to the working target object and the surrounding objects that are positioned on the right side diagonally rearward to the right from the working machine 10.

The three rear side accommodation units 92 are disposed on the brackets 74c or on the first left and right support frame 70c (refer to FIG. 5). Therefore, the three rear side accommodation units 92 are positioned more frontward than the rear end of the working machine 10, and further, more downward than the upper end of the working machine 10. Further, the three rear side accommodation units 92, together with overlapping with the operating unit 36 and the control device 72 as viewed in plan, are positioned upward of the operating handlebars 44, the operating unit 36, and the control device 72 as viewed from the side. The three rear side accommodation units 92, as viewed in plan, are positioned more on an inner side in the vehicle widthwise direction than both end parts in the vehicle widthwise direction of the auger housing 54.

From among the three rear side accommodation units 92, the rear central accommodation unit 92C is disposed in a central portion of the first left and right support frame 70c that passes through the left-right center line 16. One of the second recognition units 82 is accommodated in the rear central accommodation unit 92C. The second recognition unit 82 that is accommodated in the rear central accommodation unit 92C is a rear center second recognition unit (rearward recognition unit) 82RC. A sensor surface of the rear center second recognition unit 82RC faces rearward. The rear center second recognition unit 82RC recognizes the distance and the direction to the working target object and the surrounding objects that are positioned rearward of the working machine 10.

From among the three rear side accommodation units 92, a rear left accommodation unit 92L is disposed on a left side bracket 74c (refer to FIG. 5). One of the first recognition units 80 is accommodated in the rear left accommodation unit 92L. The first recognition unit 80 that is accommodated in the rear left accommodation unit 92L is a rear left first recognition unit (rearward recognition unit, left recognition unit, rear left recognition unit) 80RL.

The rear left first recognition unit 80RL is accommodated in the rear left accommodation unit 92L, in a manner so as to recognize an area diagonally rearward to the left from the working machine 10. More specifically, the rear left first recognition unit 80RL is positioned in the interior of the rear left accommodation unit 92L, in a manner so that a sensor surface of the rear left first recognition unit 80RL faces diagonally rearward to the left (in a leftward direction and a rearward direction) from the working machine 10. The rear left first recognition unit 80RL recognizes the distance and the direction to the working target object and the surrounding objects that are positioned diagonally rearward to the left from the working machine 10.

From among the three rear side accommodation units 92, a rear right accommodation unit 92R is disposed on a right side bracket 74c. The rear right accommodation unit 92R has a shape obtained by having left-right inverted the front left accommodation unit 92L. One of the first recognition units 80 is accommodated in the rear right accommodation unit 92R. The first recognition unit 80 that is accommodated in the rear right accommodation unit 92R is a rear right first recognition unit (rearward recognition unit, right recognition unit, rear right recognition unit) 80RR.

A rear right first recognition unit 80RR is accommodated in the rear right accommodation unit 92R, in a manner so as to recognize an area diagonally rearward to the right from the working machine 10. More specifically, the rear right first recognition unit 80RR is positioned in the interior of the rear right accommodation unit 92R, in a manner so that a sensor surface of the rear right first recognition unit 80RR faces diagonally rearward to the right (in a rightward direction and a rearward direction) from the working machine 10. The rear right first recognition unit 80RR recognizes the distance and the direction to the working target object and the surrounding objects that are positioned diagonally rearward to the right from the working machine 10.

The two position recognition units 23 are on the two brackets 74b (refer to FIG. 5). The two position recognition units 23 receive signals transmitted from non-illustrated GNSS satellites. The control device 72, based on the signals received by the two position recognition units 23, is capable of identifying the current position of the working machine 10.

As shown in FIG. 1, the plurality of surrounding vicinity recognition units 22 and the plurality of position recognition units 23 are connected to the control device 72 via wiring 100 such as a harness or the like. The wiring 100 is disposed along each of the frames that constitute the frame device 20. Further, the control device 72 is disposed on an outer side of the frame device 20. Specifically, the control device 72 is disposed more downward and rearward than the operating handlebars 44 and the frame device 20.

Further, as shown in FIG. 1, it is desirable that a departure angle θ which, as viewed from the side, is an angle between a straight line connecting a rear end portion of the traveling units 32 and a lower rear end part of the control device 72, and a ground surface of the working machine 10, be greater than or equal to a predetermined angle. In accordance with this feature, it is possible to avoid contact between the control device 72 and the ground surface, in the case that the front part of the working machine 10 rises frontward on a slope or the like, or in the case that the frame side control unit 24 is disposed by being retrofitted on the working machine main body 18.

Next, a description will be given concerning operations of the working machine 10 according to the present embodiment. In this instance, a description will be given of cases in which the working machine 10 undergoes manned and unmanned traveling.

At first, a description will be given concerning a case in which the working machine 10 undergoes manned traveling. The user, by operating the operating unit 36, causes the engine 26 and the electric motors 30 to be started. Next, in a state in which the grips 46 of the operating handlebars 44 are being held, the user causes the working machine 10 to move frontward. In accordance with this feature, the working machine 10, while moving frontward, is capable of carrying out a snow removal operation with respect to the snow that is present frontward thereof.

Specifically, the user, by operating the operating unit 36, causes the working machine 10 to move frontward, to move rearward, or to be stopped. The control device 72, in response to the operations of the operating unit 36 by the user, controls the driving of the electric motors 30, and thereby causes the working machine 10 to move frontward, to move rearward, or to be stopped. Further, the user, by operating the operating unit 36, can cause the engine 26 to be started or to be stopped.

At this time, the two position recognition units 23 are driven by the supply of electrical power from the battery 38, and start receiving signals from the GNSS satellites. The two position recognition units 23 output to the control device 72 the signals that are successively received. The control device 72, based on the signals from the two position recognition units 23, is capable of identifying the current position of the working machine 10.

Further, the plurality of surrounding vicinity recognition units 22 are driven by the supply of electrical power from the battery 38, and successively recognize the distance and the direction to the working target object and the surrounding objects that exist around the vicinity of the working machine 10. The recognition results of the plurality of surrounding vicinity recognition units 22 are sequentially output to the control device 72.

The control device 72, based on the respective recognition results of the plurality of surrounding vicinity recognition units 22, at a time when there is a possibility that the working machine 10 may collide with a surrounding object while the working machine 10 is traveling, is capable of causing the driving of the electric motors 30 to be stopped and is capable of causing the traveling of the working machine 10 to be stopped.

When the snow removal operation in the working region is completed, the user operates the operating unit 36 and thereby causes the traveling and the snow removal operation of the working machine 10 to be stopped. Consequently, the control device 72, based on the operation of the operating unit 36 by the user, stops the supply of electrical power from the battery 38 to each of the respective parts of the working machine 10. As a result, the working machine 10 stops operating.

Next, a description will be given concerning a case in which the working machine 10 travels in an unmanned manner. In the unmanned traveling, a teaching step and a playback step are carried out. In the teaching step, by the above-described manned traveling, a travel route of the working machine 10 in the working region that serves as a target of the snow removal operation is memorized in the working machine 10. In the playback step, in an unmanned state, the working machine 10 carries out the snow removal operation while traveling along the travel route that was memorized in the teaching step. More specifically, in the playback step, the working machine 10 carries out both autonomous traveling and autonomous operation.

First, in the teaching step, the manned traveling is carried out in the working region that serves as the target of the snow removal operation. At this time, the frame side control unit 24 of the control device 72 stores in a non-illustrated memory the route (the travel route) that is traveled by the working machine 10.

Next, in the playback step, the frame side control unit 24, in accordance with the travel route that is stored in the memory, controls the driving of the electric motors 30, and thereby causes the working machine 10 to travel autonomously in the working region. Further, the frame side control unit 24, by controlling the driving of the engine 26, causes the snow removal operation to be carried out autonomously.

In the playback step, the plurality of surrounding vicinity recognition units 22 successively recognize the distance and the direction to the working target object and the surrounding objects that exist around the vicinity of the working machine 10. The frame side control unit 24, based on the recognition results of the plurality of surrounding vicinity recognition units 22, at a time when there is a possibility that the working machine 10 may collide with a surrounding object while the working machine 10 is traveling, causes the driving of the electric motors 30 to be stopped, and causes the traveling of the working machine 10 to be stopped.

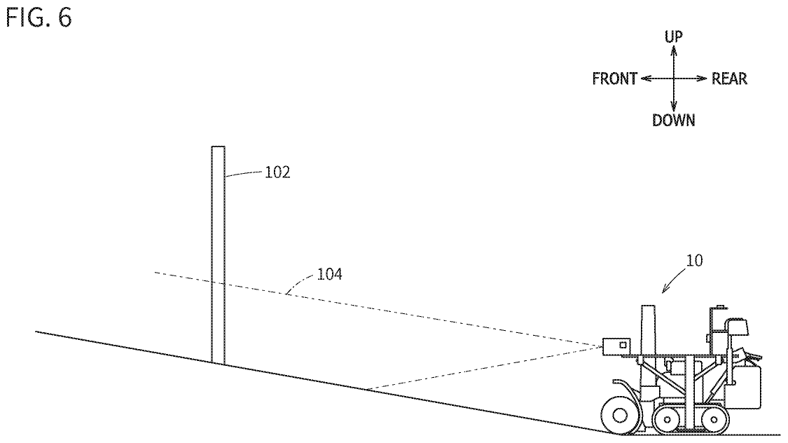

FIG. 6 to FIG. 9 are diagrams showing the recognition range of the surrounding vicinity recognition units 22 (refer to FIG. 1 to FIG. 3). In FIG. 6 to FIG. 9, a detection target 102 (for example, a person or a surrounding object) is present in front of the working machine 10.

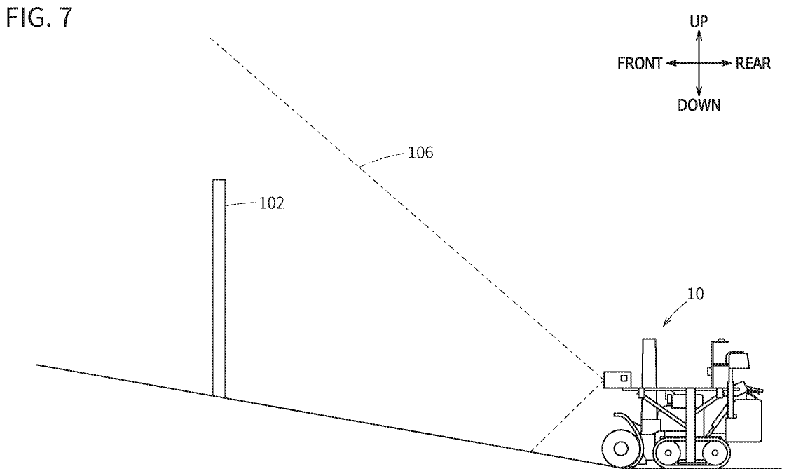

FIG. 6 is a diagram showing a recognition range 104 of the first recognition units 80 (the front left first recognition unit 80FL or the front right first recognition unit 80FR shown in FIG. 2) at a time when the working machine 10 moves frontward on an uphill slope in the frontward direction. FIG. 7 is a diagram showing a recognition range 106 of the second recognition units 82 (the front center second recognition unit 82FC shown in FIG. 2) at a time when the working machine 10 moves frontward on an uphill slope in the frontward direction. More specifically, FIG. 6 and FIG. 7 show the recognition ranges 104 and 106 (the recognition ranges in angles of elevation) at a time when the respective sensor surfaces of the first recognition unit 80 and the second recognition unit 82 face obliquely upward and frontward.

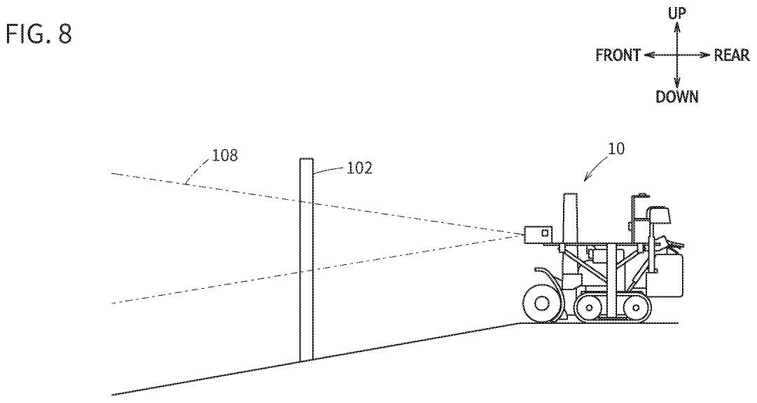

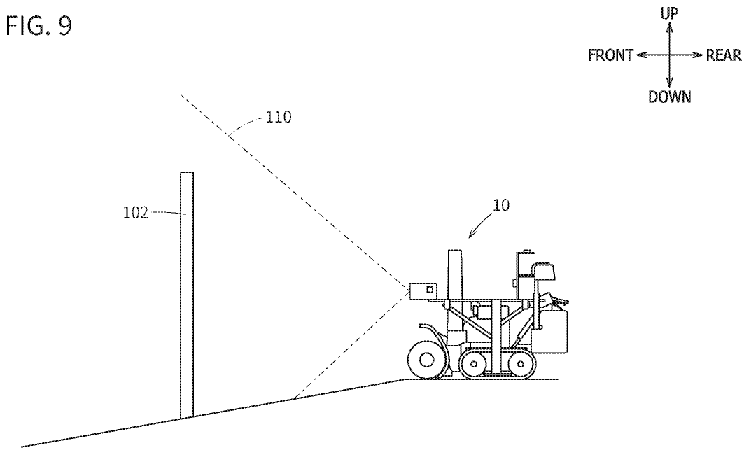

FIG. 8 is a diagram showing a recognition range 108 of the first recognition units 80 (the front left first recognition unit 80FL or the front right first recognition unit 80FR shown in FIG. 2) at a time when the working machine 10 moves frontward on a downhill slope in the frontward direction. FIG. 9 is a diagram showing a recognition range 110 of the second recognition units 82 (the front center second recognition unit 82FC shown in FIG. 2) at a time when the working machine 10 moves frontward on a downhill slope in the frontward direction. More specifically, FIG. 8 and FIG. 9 show the recognition ranges 108 and 110 (the recognition ranges in angles of elevation) at a time when the respective sensor surfaces of the first recognition unit 80 and the second recognition unit 82 face obliquely downward and frontward.

In any of the cases shown in FIG. 6 to FIG. 9, at least a portion of the detection target 102 falls within the recognition ranges 104, 106, 108, and 110 of the first recognition unit 80 and the second recognition unit 82 (refer to FIG. 1 to FIG. 3). Accordingly, in the present embodiment, the detection target 102 can be satisfactorily detected.

The present embodiment is not necessarily limited to the configuration described above.

The working machine 10 may be another working machine that is equipped with a crawler belt. Specifically, as such a working machine, there may be cited various types of construction equipment such as cranes, excavators, bulldozers, and the like.

The working machine 10 may be another working machine that is equipped with vehicle wheels. Specifically, as such a working machine, there may be cited (1) transportation equipment such as transport vehicles, forklifts, and the like, (2) landscaping equipment such as manned or unmanned lawn mowers, robotic lawn mowers, and the like, and (3) agricultural machinery such as tractors, cultivators, combine harvesters, and the like.

The working machine 10 may be a working machine having a ski shaped traveling unit. Specifically, as such a working machine, there may be cited a snowmobile, a snow groomer, or the like. Snowmobiles include ski shaped traveling units (skis or crawlers) and are capable of moving and performing working on snow.

The working machine 10 may be a working machine in which the working unit 28 is driven by the motive power of an electric motor. Alternatively, the working machine 10 may be a hybrid working machine in which the working unit 28 is driven by the motive power of two drive sources including an engine and an electric motor.

The working machine 10 may be a working machine that travels by means of the motive power of an engine. Alternatively, the working machine 10 may be a hybrid working machine that travels by means of the motive power of two drive sources including an engine and an electric motor.

The frame device 20 need only be connected to a portion of the vehicle body frame 34 where the vibrations that are generated at a time when the working machine 10 is in operation are relatively small. Therefore, the frame device 20 may be mounted on the drive shaft portions 50a or the rolling shaft portions 50b. Further, in the case that the working machine 10 is not equipped with crawlers, the frame device 20 may be mounted on am axle portion of the working machine 10.

The surrounding vicinity recognition units 22 need only be capable of recognizing the surrounding vicinity of the working machine 10. Therefore, the surrounding vicinity recognition units 22 may be a camera or a sonar. Further, the position recognition units 23 may recognize the current position of the working machine 10 using an inertial measurement device.

The control device 72, by being equipped with a non-illustrated communication interface, may carry out wireless communication with the exterior of the working machine 10. In this case, by carrying out wireless communication with an external device, in accordance with an instruction from the external device, the control device 72 is capable of carrying out autonomous traveling and autonomous operation of the working machine 10.

The plurality of surrounding vicinity recognition units 22 and the frame side control unit 24 may be mounted directly on the vehicle body frame 34. Alternatively, the plurality of surrounding vicinity recognition units 22 and the frame side control unit 24 may be mounted on the vehicle body frame 34 via non-illustrated stays.

The following supplementary notes are further disclosed in relation to the above-described embodiment.

### Supplementary Note 1

An electronic device support structure (20) of the present disclosure is an electronic device support structure for supporting an electronic device (22, 23, 72) connectable to a working machine (10) includes a support portion (62) configured to support the electronic device, and a connecting portion (64) connected to the support portion and connected to a vehicle body frame (34) of the working machine.

According to this configuration, since the electronic device is mounted on the working machine via the electronic device support structure, the working machine can perform at least one of autonomous traveling and autonomous operation depending on the surrounding situation by using the electronic device. In addition, since the connecting portion is connected to the vehicle body frame, which has relatively high rigidity, the electronic device can be appropriately supported with respect to the working machine.

### Supplementary Note 2

In the electronic device support structure according to Supplementary Note 1, the connecting portion may be attachable to and detachable from the vehicle body frame.

According to this configuration, the electronic device can be easily mounted on an existing working machine.

### Supplementary Note 3

In the electronic device support structure according to Supplementary Note 1 or 2, the connecting portion may be attached to the vehicle body frame in a manner so that a relative position of the connecting portion to the vehicle body frame is adjustable.

According to this configuration, the relative position of the electronic device with respect to the working machine can be easily adjusted.

### Supplementary Note 4

In the electronic device support structure according to any one of Supplementary Notes 1 to 3, the connecting portion may be attached to a portion of the vehicle body frame where vibrations generated when the working machine is in operation are relatively small.

According to this configuration, vibrations transmitted from the working machine to the electronic device can be suppressed and noise to the electronic device can be reduced.

### Supplementary Note 5

In the electronic device support structure according to any one of Supplementary Notes 1 to 4, the working machine may include a traveling unit (32) configured to cause the working machine to travel, and the connecting portion may be attached to a first partial frame (42) of the vehicle body frame, the first partial frame supporting the traveling unit.

According to this configuration, vibrations transmitted from the working machine to the electronic device via the first partial frame are suppressed and thus noise to the electronic device can be effectively reduced.

### Supplementary Note 6

In the electronic device support structure according to any one of Supplementary Notes 1 to 5, the working machine may further include an operating unit (36) configured to be operated by a user of the working machine, and the connecting portion may be attached to a second partial frame (44) of the vehicle body frame, the second partial frame supporting the operating unit.

According to this configuration, vibrations transmitted from the working machine to the electronic device via the second partial frame are suppressed and thus noise to the electronic device can be effectively reduced.

### Supplementary Note 7

In the electronic device support structure according to any one of Supplementary Notes 1 to 6, the electronic device may include a recognition unit (22) configured to recognize a surrounding vicinity of the working machine, and the support portion may support the recognition unit above the working machine at a position forward of a front-rear center (14), which is a center in a front-rear direction of the working machine.

According to this configuration, the situation in front of the working machine can be recognized.

### Supplementary Note 8

In the electronic device support structure according to any one of Supplementary Notes 1 to 7, the electronic device may include a recognition unit configured to recognize a surrounding vicinity of the working machine, and the support portion may support the recognition unit above the working machine at a position rearward of a front-rear center, which is a center in a front-rear direction of the working machine.

According to this configuration, the situation behind the working machine can be recognized.

### Supplementary Note 9

In the electronic device support structure according to any one of Supplementary Notes 1 to 8, the electronic device may include a recognition unit configured to recognize a surrounding vicinity of the working machine, and the support portion may support the recognition unit above the working machine at a position leftward of a left-right center (16), which is a center in a left-right direction of the working machine.

According to this configuration, the situation on the left side of the working machine can be recognized.

### Supplementary Note 10

In the electronic device support structure according to any one of Supplementary Notes 1 to 9, the electronic device may include a recognition unit configured to recognize a surrounding vicinity of the working machine, and the support portion may support the recognition unit above the working machine at a position rightward of a left-right center, which is a center in a left-right direction of the working machine.

According to this configuration, the situation on the right side of the working machine can be recognized.

### Supplementary Note 11

In the electronic device support structure according to any one of Supplementary Notes 1 to 10, the electronic device may include a control unit configured to control the working machine, and the support portion may support the control unit at a position rearward of a front-rear center, which is a center in a front-rear direction of the working machine.

According to this configuration, the control unit can be easily mounted on the working machine.

### Supplementary Note 12

In the electronic device support structure according to any one of Supplementary Notes 1 to 11, the electronic device may include a recognition unit configured to recognize a surrounding vicinity of the working machine and a control unit configured to control the working machine, the recognition unit and the control unit may be electrically connected via wiring (100), and the wiring may be arranged along at least one of the support portion and the connecting portion.

In accordance with such a configuration, the wiring can be appropriately protected.

### Supplementary Note 13

In the electronic device support structure according to any one of Supplementary Notes 1 to 12, the support portion may include a plurality of support frames configured to support the electronic device.

According to this configuration, the electronic device can be more easily mounted on an existing working machine.

### Supplementary Note 14

A working machine of the present disclosure includes the electronic device support structure according to any one of Supplementary Notes 1 to 13.

### Supplementary Note 15

A frame device (20) of the present disclosure includes: a support portion configured to support an electronic device configured to be connected to a working machine; and a connecting portion connected to the support portion and connected to a vehicle body frame of the working machine.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

What is claimed is:

1. An electronic device support structure for supporting an electronic device connectable to a working machine, comprising:
a support portion configured to support the electronic device; and
a connecting portion connected to the support portion and connected to a vehicle body frame of the working machine.

2. The electronic device support structure according to claim 1, wherein
the connecting portion is attachable to and detachable from the vehicle body frame.

3. The electronic device support structure according to claim 1, wherein
the connecting portion is attached to the vehicle body frame in a manner so that a relative position of the connecting portion to the vehicle body frame is adjustable.

4. The electronic device support structure according to claim 1, wherein
the connecting portion is attached to a portion of the vehicle body frame where vibrations generated when the working machine is in operation are relatively small.

5. The electronic device support structure according to claim 1, wherein
the working machine includes a traveling unit configured to cause the working machine to travel, and
the connecting portion is attached to a first partial frame of the vehicle body frame, the first partial frame supporting the traveling unit.

6. The electronic device support structure according to claim 1, wherein
the working machine further includes an operating unit configured to be operated by a user of the working machine, and
the connecting portion is attached to a second partial frame of the vehicle body frame, the second partial frame supporting the operating unit.

7. The electronic device support structure according to claim 1, wherein
the electronic device includes a recognition unit configured to recognize a surrounding vicinity of the working machine, and
the support portion supports, above the working machine, the recognition unit at a position forward of a front-rear center, which is a center in a front-rear direction of the working machine.

8. The electronic device support structure according to claim 1, wherein
the electronic device includes a recognition unit configured to recognize a surrounding vicinity of the working machine, and
the support portion supports, above the working machine, the recognition unit at a position rearward of a front-rear center, which is a center in a front-rear direction of the working machine.

9. The electronic device support structure according to claim 1, wherein
the electronic device includes a recognition unit configured to recognize a surrounding vicinity of the working machine, and
the support portion supports, above the working machine, the recognition unit at a position leftward of a left-right center, which is a center in a left-right direction of the working machine.

10. The electronic device support structure according to claim 1, wherein
the electronic device includes a recognition unit configured to recognize a surrounding vicinity of the working machine, and
the support portion supports, above the working machine, the recognition unit at a position rightward of a left-right center, which is a center in a left-right direction of the working machine.

11. The electronic device support structure according to claim 1, wherein
the electronic device includes a control unit configured to control the working machine, and
the support portion supports the control unit at a position rearward of a front-rear center, which is a center in a front-rear direction of the working machine.

12. The electronic device support structure according to claim 1, wherein
the electronic device includes a recognition unit configured to recognize a surrounding vicinity of the working machine and a control unit configured to control the working machine,
the recognition unit and the control unit are electrically connected via wiring, and
the wiring is arranged along at least one of the support portion or the connecting portion.

13. The electronic device support structure according to claim 1, wherein
the support portion includes a plurality of support frames configured to support the electronic device.

14. A working machine comprising the electronic device support structure according to claim 1.

15. A frame device comprising:
a support portion configured to support an electronic device configured to be connected to a working machine; and
a connecting portion connected to the support portion and connected to a vehicle body frame of the working machine.
